(19) United States
(12) Patent Application Publication
(10) Pub. No.: US 2025/0165276 A1
(43) Pub. Date: May 22, 2025

(54) ENABLING WARM-START STANDBY SERVERS FOR TEMPORARILY AVAILABLE RESOURCES

(71) Applicant: RedHat, Inc., Raleigh, NC (US)

(72) Inventors: Gabriel Zvi BenHanokh, Ra'anana (IL); Yehoshua Salomon, Ra'anana (IL)

(21) Appl. No.: 18/499,536

(22) Filed: Nov. 20, 2023

(51) Int. Cl. G06F 9/455

(52) U.S. Cl. CPC G06F 9/45558; G06F 2009/45562

(57) ABSTRACT

Embodiments of the present disclosure relate to managing or controlling a warm-start of an application. A shutdown notification may be received for a first virtualization environment. Application state information associated with an application executing on the first virtualization environment may be obtained, the application state information divided into chunks. The obtained application state information may be sent to a warm-start service to be delivered to a second virtualization environment.

### TECHNICAL FIELD

Aspects of the present disclosure relate to cloud computing, and more particularly, to managing a warm-start of applications on computers.

### BACKGROUND

Spot instances can provide a cost-effective solution for stateless workloads in a cloud environment by allowing users access to cloud providers' unused or spare computing capacity, thus providing an opportunity to reduce costs while obtaining high computational power. Spot instances can provide flexibility, scalability, and cost-efficiency to an organization's computing workload, allowing businesses and individuals to optimize their workloads and stretch their computing budgets. However, a spot instance can also be taken away very quickly, so as to be given to a cloud customer paying full price, resulting in disruptions to computing operations.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments without departing from the spirit and scope of the described embodiments.

FIG. 1 is a block diagram that illustrates an example warm-start management architecture, in accordance with some embodiments.

FIG. 2 is a block diagram of a warm-start management architecture, in accordance with some embodiments.

FIG. 3 is a structure diagram of a warm-start management cache, in accordance with some embodiments.

FIG. 4 is a flow diagram of a method of managing or controlling a warm-start, in accordance with some embodiments.

FIG. 5 is a component diagram depicting an example warm-start management architecture, in accordance with embodiments of the disclosure.

FIG. 6 is a block diagram of an example computing device that may perform one or more of the operations described herein, in accordance with some embodiments of the present disclosure.

### DETAILED DESCRIPTION

Preemptible instances, also referred to as spot instances, can be very cost-effective solutions for stateless workloads in a cloud environment. Traditional cloud pricing models, including on-demand instances, offer users the convenience of accessing computing resources whenever needed. However, this convenience can come at a premium, as users pay for guaranteed availability By contrast, spot instances represent a pricing model, offered by cloud service providers, which offers a discount for providers' unused or spare computing capacity, providing an opportunity to reduce costs while obtaining high computational power. Spot instances can provide flexibility, scalability, and cost-efficiency to an organization's computing workload, allowing businesses and individuals to optimize their workloads and stretch their computing budgets.

While spot instances can provide substantial cost savings, they are not suitable for all types of workloads. Applications that are tolerant of interruptions and can accommodate instance termination, such as data analysis, batch processing, and rendering, may be ideal candidates for spot instances. On the other hand, applications that require constant availability and are sensitive to interruptions, such as real-time services or critical production workloads, might be better served by on-demand or reserved instances.

Despite their challenges, spot instances have transformed the economics of cloud computing, enabling businesses of all sizes to access substantial computational power at a fraction of the cost of reserved instances. Startups and small enterprises with limited budgets can leverage spot instances to compete with larger counterparts without compromising performance. Similarly, large enterprises can use spot instances to optimize their cloud spending and direct their savings towards innovation and growth.

Transferring an application to a new instance as a result of eviction may be less of an issue for an application that is “stateless” and does not require the preservation of state. However, even though an application may be stateless from a functional perspective, it may maintain internal state. Consequently, migrating the application to another platform, without also migrating its state, e.g., a “cold” start, can result in the application underperforming for a period of time while it reconstructs its state on the new platform. Furthermore, eviction may provide insufficient time for all of an application's state to be migrated to a new instance. Thus, it can be desirable to provide a mechanism to migrate a prioritized portion of an application's internal state (from an instance for which an eviction notification has been received) to a new instance, in order to minimize the time that the migrated application underperforms while it is reconstructing its internal state.

Migrating application state information, e.g., a read cache, on a best effort basis, can be distinguished from relying on a hot spare server that is continuously updated with state changes. Thus we are not employing an active/standby solution. We can take any “hot spare” instance it and “warm it up” so it starts from a better state than a cold start, but not necessarily as “hot” as the evicted spot instance.

A solution to this challenge is to transfer the state to another instance in small priority-based chunks. In some embodiments, a cache mechanism can allow transferring the data in most-recently-used (MRU), or reverse least-recently-used order. In some embodiments, use of a weighted cache allows prioritization based on other dimensions, e.g., how complex it was to fetch the data, or read prediction probability. In some embodiments, a policy can support moving smaller (or larger) data items first. In another embodiment, the contents of a metadata cache are transferred first, after which the contents of the data cache are transferred. In some embodiments, metadata comprises additional data that describes other data, e.g., a location, in memory or on disk, of desired data. In some cases, this can reduce the number of input/output (I/O) operations necessary to retrieve the desired data. In some embodiments, data is transferred to an already-running virtualization environment, e.g., a hot spare. In some embodiments, a new virtualization environment is launched to receive the data. In some embodiments, application state information is provided and transferred in self-contained chunks, wherein an application can consume a chunk of application state data independently of other chunks and a chunk does not depend on application state data that has not yet been transferred. In some embodiments, these chunks are prioritized. In some embodiments, this prioritization allows more important chunks to be moved first, to anticipate a scenario in which eviction of the source system completes before all the chunks of application state information are successfully moved to the target system. In some embodiments, prioritization can be static, e.g., by application according to a manifest, or dynamic, e.g., across all application with input from the application which specifies which state information is more valuable. In some embodiments, the order in which the application transfers application state data determines its priority, e.g., most important application state data is transferred first. In some embodiments, comprising a set of applications, a manifest can enable a warm start service to prioritize the transfer of application state across multiple applications. For example, a manifest may indicate that the transfer of a first application's state information should be prioritized over the transfer of a second application's state information.

An ability to pass data in small stand-alone chunks can be important as an all-or-nothing approach can fail if eviction completes before all of the state can be transferred. The ability to pass data in small stand-alone chunks can allow state to be transferred first for higher priority applications, or for higher priority state within applications.

In some embodiments, a participating application provides some data about its cache items and their priority. In some embodiments, this data is provided via a callback mechanism. In some embodiments, the data is obtained and transferred via a centralized warm-start service. In some embodiments, a warm-start service can prioritize the data of some applications over that of other applications. In some embodiments, a generic mechanism can be implemented in a cluster infrastructure that can schedule the transfer of application state based on information from the applications. In some embodiments, the application may divide its own application state information into a first collection and a lower priority second collection, with the application transferring the first collection before the second collection. In some embodiments, the participating application is responsible for prioritizing the application state information to be transferred.

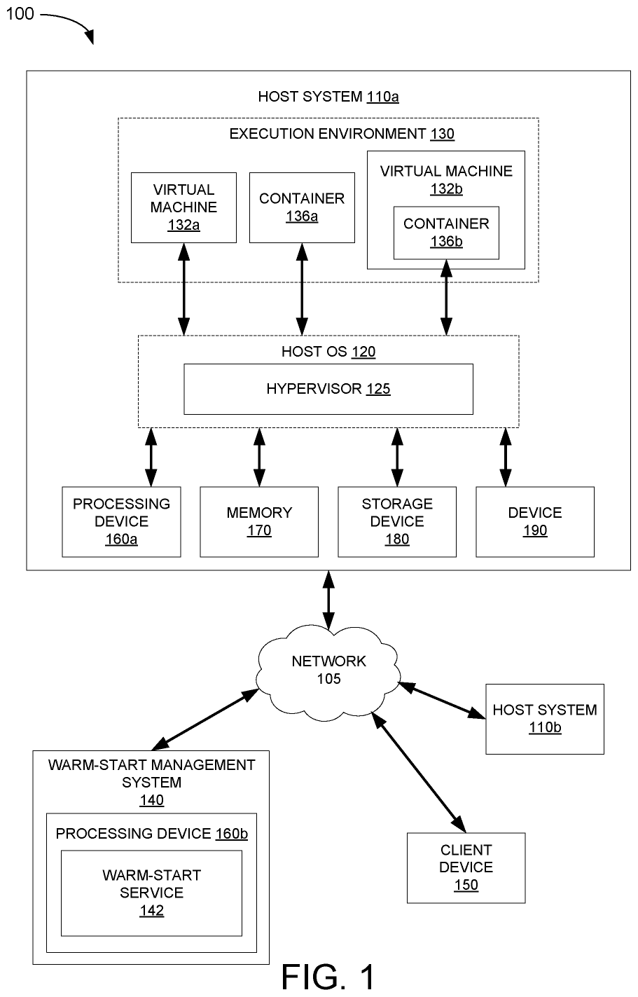

FIG. 1 is a block diagram that illustrates an example warm-start management architecture 100, in accordance with some embodiments. However, other warm-start management architectures are possible, and the implementation of a computer system utilizing examples of the disclosure are not necessarily limited to the specific architecture depicted by FIG. 1.

As shown in FIG. 1, warm-start management architecture 100 includes host systems 110a and 110b, warm-start management system 140, and client device 150. The host systems 110a and 110b, warm-start management system 140, and client device 150 may each include hardware such as processing devices 160a and 160b, memory 170, which may include volatile memory devices, e.g., random access memory (RAM), non-volatile memory devices, e.g., flash memory, and/or other types of memory devices, a storage device 180, e.g., one or more magnetic hard disk drives, a Peripheral Component Interconnect (PCI) solid state drive, a Redundant Array of Independent Disks (RAID) system, or a network attached storage (NAS) array, and one or more devices 190, e.g., a Peripheral Component Interconnect (PCI) device, a network interface controller (NIC), a video card, or an I/O device. In certain implementations, memory 170 may be non-uniform access (NUMA), such that memory access time depends on the memory location relative to processing devices 160a and 160b. It should be noted that although, for simplicity, a single processing device 160a or 160b, storage device 180, and device 190 are depicted in FIG. 1, other embodiments of host systems 110a and 110b, warm-start management system 140, and client device 150 may include multiple processing devices, storage devices, or devices. Processing devices 160a and 160b may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing devices 160a and 160b may also include one or more special-purpose processing devices such as an application specific integrated circuit (ASIC), a field programmable gate array (FPGA), a digital signal processor (DSP), network processor, or the like.

Each of the host systems 110a and 110b, warm-start management system 140, and client device 150 may be a server, a mainframe, a workstation, a personal computer (PC), a mobile phone, a palm-sized computing device, etc. In some embodiments, host systems 110a and 110b, warm-start management system 140, and/or client device 150 may be separate computing devices. In some embodiments, host systems 110a and 110b, warm-start management system 140, and/or client device 150 may be implemented by a single computing device. For clarity, some components of warm-start management system 140, host system 110b, and client device 150 are not shown. In some embodiments, warm-start management system 140 may include a virtual machine-orchestration system. Furthermore, although warm-start management architecture 100 is illustrated as having two host systems, embodiments of the disclosure may utilize any number of host systems.

Host systems 110a and 110b, and warm-start management system 140, may also include an execution environment 130, which may include one or more virtual machines (VMs) 132a, containers 136a, containers 136b residing within virtual machines 132b, and a host operating system (OS) 120. VMs 132a and 132b are software implementations of machines that execute programs as though they were actual physical machines. Containers 136a and 136b can act as isolated execution environments for different workloads of services. Host OS 120 manages the hardware resources of the host system 110a and provides functions such as inter-process communication, scheduling, memory management, and so forth. A container, virtual machine, or any combination of containers and virtual machines may be referred to as a virtualization environment.

Host OS 120 may include a hypervisor 125, also known as a virtual machine monitor (VMM), which can provide a virtual operating platform for VMs 132a and 132b and manage their execution. Hypervisor 125 may manage system resources, including access to physical processing devices, e.g., processors or CPUs, physical memory, e.g., RAM, storage devices, e.g., HDDs or SSDs, and other devices, e.g., sound cards or video cards. The hypervisor 125, typically implemented in software, may emulate and export a bare machine interface to higher level software in the form of virtual processors and guest memory. Higher level software may comprise a standard or real-time OS, may be a highly stripped-down operating environment with limited operating system functionality, and may include traditional OS facilities, etc. Hypervisor 125 may present other software, i.e., “guest” software, the abstraction of one or more VMs that provide the same or different abstractions to various guest software, e.g., a guest operating system or guest applications. It should be noted that in some alternative implementations, hypervisor 125 may be external to host OS 120, rather than embedded within host OS 120, or may replace host OS 120.

The host systems 110a and 110b, warm-start management system 140, and client device 150 are coupled to each other, e.g., may be operatively coupled, communicatively coupled, or may communicate data/messages with each other, via network 105. Network 105 may be a public network, e.g., the internet, a private network, e.g., a local area network (LAN) or a wide area network (WAN), or a combination thereof. In one embodiment, network 105 may include a wired or a wireless infrastructure, which may be provided by one or more wireless communications systems, such as a WiFi™ hotspot connected with the network 105 and/or a wireless carrier system that can be implemented using various data processing equipment and communication towers, e.g., cell towers. The network 105 may carry communications, e.g., data, messages, packets, or frames, between the various components of host systems 110a and 110b, warm-start management system 140, and/or client device 150.

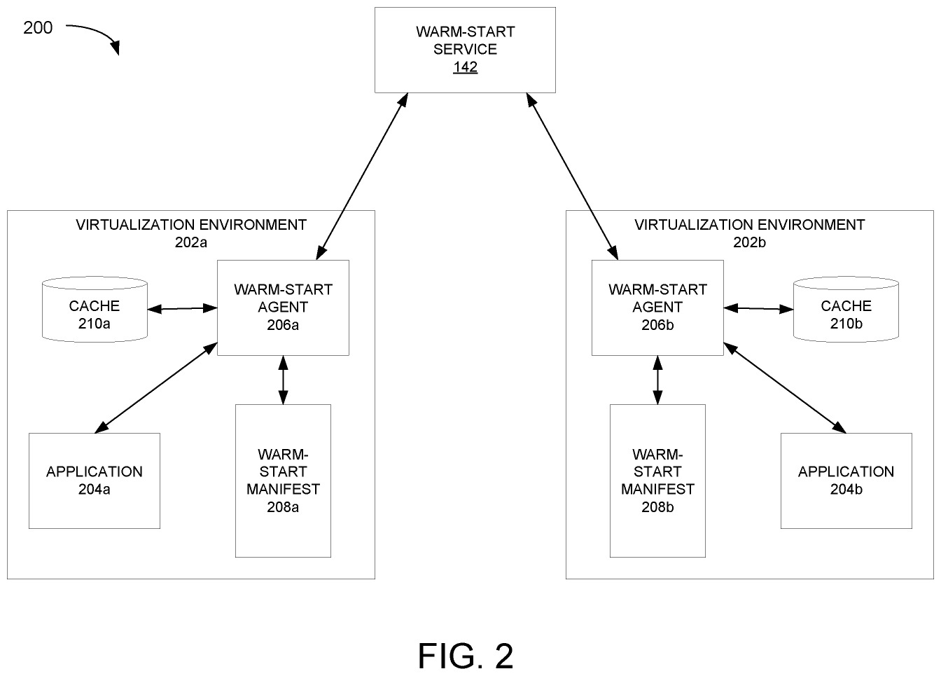

In some embodiments, processing device 160b may execute warm-start service 142. In some embodiments, warm-start service 142 may receive a notification from a host system 110a that a virtual machine, container, or the host system itself is shutting down and an application needs to be migrated to another virtual machine, container, or host system. In some embodiments, warm-start service 142 may receive a request from client device 150 to marshal application state data from one or more applications. In computer science, marshaling is the process of obtaining and transforming the memory representation of an object into a data format suitable for storage or transmission. It can be used when data is to be moved between different parts of a computer program or from one program to another. In some embodiments, warm-start service 142 may detect an eviction notice directed to a first VM. In some embodiments, warm-start service 142 may detect an eviction notice directed to a first container. In some embodiments, warm-start service 142 may collect application state data from a first VM or container and transfer the application state data to a second VM or container. In some embodiments, warm-start service 142 may obtain the application state data through a warm-start agent executing on the first VM or container. In some embodiments, warm-start service 142 may transfer the application state data to a warm-start agent executing on the second VM or container. Warm-start service 142 may identify one or more warm-start manifests that can be obtained from the warm-start agent executing on the first VM or container and provided to the warm-start agent executing on the second VM or container. Further details regarding warm-start service 142 will be discussed in the context of FIGS. 2-6 below.

FIG. 2 is a block diagram 200 of a warm-start management architecture, in accordance with some embodiments. FIG. 2 includes virtualization environment 202a, in which an application 204a is executing. Virtualization environment 202a can also include a warm-start agent 206a, a warm-start manifest 208a, and a cache 210a. A second virtualization environment 202b also includes an application 204b, and may include a warm-start agent 206b, a warm-start manifest 208b, and a cache 210b. In some embodiments, virtualization environments 202a and 202b may correspond to virtual machines 132a or 132b of FIG. 1. In some embodiments, warm-start service 142 corresponds to warm-start service 142 of FIG. 1. A virtualization environment may include any combination of virtual machines and containers.

Referring to FIG. 2, warm-start agent 206a monitors the status of virtualization environment 202a. In some embodiments, warm-start service 142 may receive an eviction notice associated with virtualization environment 202a and convey the eviction notice to warm-start agent 206a. In some embodiments, warm-start agent 206a may receive an eviction notice from virtualization environment 202a. In some embodiments, warm-start agent 206a may receive an eviction notice from a client device. In some embodiments, warm-start agent 206a and warm-start service 142 will keep each other apprised of any eviction notices associated with virtualization environment 202a.

In some embodiments, upon receiving an eviction notice, warm-start agent 206a will read warm-start manifest 208a and obtain a list of application state data to be transferred to another instance of the application. In some embodiments, warm-start agent 206a, driven by warm-start manifest 208a, will extract application state data from application 204a, and provide it to warm-start service 142. In some embodiments, warm-start service 142 will cause virtualization environment 202b to be instantiated. In some embodiments, warm-start service 142 will identify an already-instantiated virtualization environment on which to launch application 204b. In some embodiments, all of the application state data may not be transferred to warm-start service 142 before virtualization environment 202a is evicted and shut down. In some embodiments, application state information can be transferred in self-contained chunks such that an application can consume a chunk as an atomic unit, either without a dependency on another chunk or without a dependency on a chunk that has not been already transferred. In some embodiments, the chunks are prioritized. In some embodiments, this prioritization allows more important chunks to be moved first, to anticipate a scenario in which eviction of the source system completes before all the chunks of application state information are successfully moved to the target system. In some embodiments, prioritization can be static, e.g., by application according to a manifest, or dynamic, e.g., across all application with input from the application which specifies which state information is more valuable.

In some embodiments, warm-start service 142, as it receives, through warm-start agent 206a, application state data from application 204a, sends the application state data to warm-start agent 206b in virtualization environment 202b. In some embodiments, warm-start agent 206b will launch application 204b in virtualization environment 202b. In some embodiments, warm-start agent 206b will store the application state data in cache 210b before providing it to application 204b. In some embodiments, this allows the transfer of application state data to occur in parallel with launching the target containers and their applications. In some embodiments, warm-start agent 206b will reference warm-start manifest 208b to identify the application state data to be cached and the order in which the cached application state data should be provided to application 204b. In some embodiments, warm-start agent 206b may not receive, via warm-start service 142, all the desired application state data from warm-start agent 206a before virtualization environment 202a is evicted and shut down. In some embodiments, multiple applications executing in virtualization environment 202a may provide application state data to warm-start service 142, and application state data may be forwarded to multiple warm-start agents executing in multiple virtualization environments. In some embodiments, warm-start manifests 208a and 208b may include references to application state data for multiple applications. In some embodiments, the warm-start service is co-resident on a target virtualization environment so as to minimize the amount of network traffic. In some embodiments, the warm start service executes on an on-demand or reserved instance.

In some embodiments, after launching on virtualization environment 202b, application 204b will communicate with warm-start agent 206b to preload the transferred application state data. In some embodiments, the transferred application state data will come from cache 210b. In some embodiments the transferred application state data will be obtained directly from warm-start agent 206b.

An important consideration is that upon receiving an eviction notice and starting to pass data to the warm-start service 142, warm-start agent 204a may not be able to pass all the desired data before virtualization environment 202a is terminated. Consequently, in some embodiments, the application state data extracted from application 204a is ordered in small, prioritized chunks by warm-start agent 204a. In some embodiments, the chunks are prioritized using different weighting methods. In some embodiments, application state data is marshaled according to the complexity of fetching the data. In some embodiments, application state data is marshaled according to read prediction probability. In some embodiments, read prediction probability is a measure of the likelihood that a particular data item will need to be retrieved from storage. In some embodiments, larger data items are passed first. In some embodiments, smaller data items are prioritized.

In some embodiments, the warm-start manifests 208a and 208b contain a list of applications, their respective application state data, and priorities for migrating application state data. In some embodiments, application state data will be passed to the warm-start service 142, and then to the new virtualization environment's warm-start agent 204b, in most-recently-used (MRU) order. In some embodiments, the MRU order may be determined by using a reverse least-recently-used (rLRU) algorithm. In some embodiments, the application state data to be passed may be prioritized by the warm-start service 142, giving higher priority to migration of application state data from a particular application. In some embodiments, rather than through the use of a warm-start manifest, application 204a or warm-start agent 206a provides information on cache items associated with application 204a and their priority to warm-start service 142.

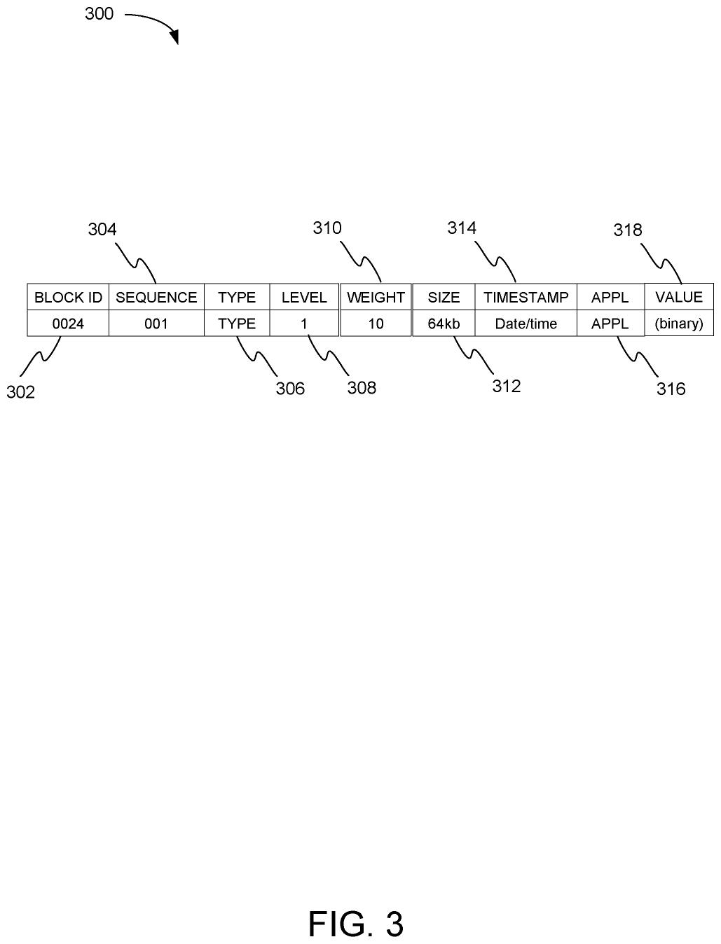

FIG. 3 is a structure diagram of a warm-start management cache 300, in accordance with some embodiments. The cache 300 can store a variety of application state data records that can, under eviction conditions, be transferred to another virtualization environment. In some embodiments, a record in the cache 300 may comprise a block id field 302 that references a particular state location in a particular application. In some embodiments, the block id may reference a memory location.

The records in the cache 300 may also comprise a sequence field 304. In some embodiments, the sequence may allow multiple records associated with a particular block id 302 to be ordered in the cache 300. In some embodiments, depending on the size of state data in the cache 300, multiple records may be required to store a particular state data element. The use of a sequence field can allow proper ordering of the multiple records.

The records in the cache 300 may also comprise a type field 306. In some embodiments, the type may indicate whether the record is associated with an application or with the virtualization environment itself. In some embodiments, the type field 306 may indicate whether a record represents actual data or metadata.

In many systems, especially those that store large amounts of data and manage the data layouts themselves, e.g., file systems, modern block storage systems, and databases, there can be a need for additional data that describes the exact location, in memory or on disk, of the desired data. In some cases, this can reduce the number of input/output (I/O) operations necessary to retrieve the data. For example, a file may be 100 GB in size, but only 64 kb, offset 25 Gb into the file, is needed. In order to save I/O overhead, we want to know the location of the 16 disk blocks that hold the desired 64 kb and issue I/O requests only for those 16 blocks. In some embodiments, this data (data that describes other data) is called metadata.

As this data is often part of the storage or database system it is persistent with the “real” user data. Often, reading user data requires first reading the metadata (or accessing it from the cache), so having this data available can avoid a set of read operations.

The records in the cache 300 may comprise a level field 308. In some embodiments, the level field may allow multiple levels of application state to be cached. For example, application state possessing a level of one may be more valuable cached data that should be transferred before application state possessing a lower level, e.g., fifteen.

The records in the cache 300 may comprise a weight field 310. In some embodiments, the weight field may allow various weightings of application state to be cached. For example, application state possessing a weight of ten may be more valuable cached data that should be transferred before application state possessing a weight of five. In some embodiments, the lower the weight, the higher the value of the application state data. For example, application state data possessing a weight of ten may have a higher value than application state data possessing a weight of one hundred.

The records in the cache 300 may comprise a size field 312. In some embodiments, the size field may comprise the actual size, e.g., in bytes, kilobytes, or megabytes. In some embodiments, smaller application state data may be transferred before larger application state data

The records in the cache 300 may comprise a timestamp field 314. In some embodiments, the timestamp field may comprise the time and date that the application state data was written. In some embodiments, more recent application state data may be transferred before older application state data.

The records in the cache 300 may comprise an application (APPL) field 316. In some embodiments, the application field 312 may include the name of the application whose state is being cached. In some embodiments, as indicated in FIG. 2, the warm-start manifest 208 may provide a list of prioritized application state to be saved to the cache 210a and migrated to new virtualization environment 202b. In some embodiments, prioritized application state data can be transferred before other application state data.

The records in the cache 300 may comprise a value field 318. In some embodiments, the value field 318 may include the actual data associated with the memory location or application state represented by the record.

Other fields are contemplated for allowing the transfer of application state data to be prioritized.

In some embodiments, all records of the cache are of fixed size. In some embodiments, the sizes of the records in the cache vary according to the size of the data stored in the record.

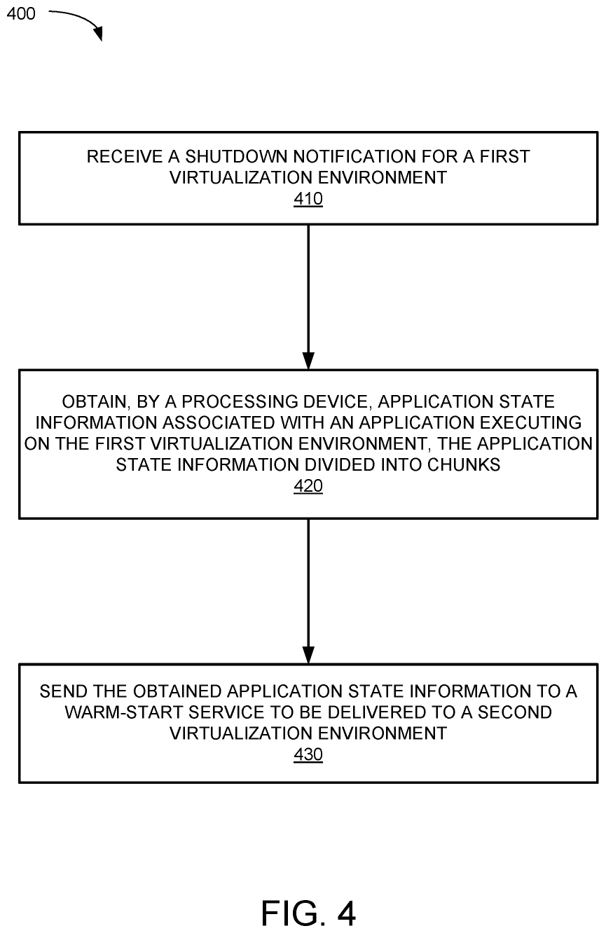

FIG. 4 is a flow diagram of a method 400 of managing or controlling a warm-start, in accordance with some embodiments. Method 400 may be performed by processing logic that may comprise hardware, e.g., circuitry, dedicated logic, programmable logic, a processor, a processing device, a central processing unit (CPU), a system-on-a-chip (SoC), software, e.g., instructions running/executing on a processing device, firmware, e.g., microcode, or a combination thereof. In some embodiments, at least a portion of method 400 may be performed by warm-start management system 140 of FIG. 1.

With reference to FIG. 4, method 400 illustrates example functions used by various embodiments. Although specific function blocks (“blocks”) are disclosed in method 400, such blocks are examples. That is, some embodiments are well suited to performing various other blocks or variations of the blocks recited in method 400. It is appreciated that the blocks in method 400 may be performed in an order different than presented, and that not all of the blocks in method 400 may be performed.

Method 400 begins at block 410, where the processing logic receives a shutdown notification for a first virtualization environment. In some embodiments, the shutdown notification is obtained by a warm-start agent corresponding to warm-start agent 206a of FIG. 2. In some environments, instructions to the warm-start agent may be provided by a warm-start service similar to warm-start service 142 of FIG. 2. In some embodiments, the warm-start service 142 of FIG. 2 may correspond to the warm-start service 142 of FIG. 1.

At block 420, the processing logic obtains, by a processing device, application state information associated with an application executing on the first virtualization environment, the application state information divided into chunks. In some embodiments, the application state information is divided into chunks according to criteria defined by the application. In some embodiments, this criteria specifies the application state data, its priority, and its characteristics, e.g., chunk size. In some embodiments, a particular application can have multiple classes of application state information, the different classes of application state information having different priorities. In some embodiments, an application may first transfer its higher priority application state information, followed by its lower priority application state information, as time permits. In some embodiments, the application state information is obtained by marshaling. Marshaling is a process of obtaining and transforming the memory representation of an object into a data format suitable for storage or transmission. It can be used when data is to be moved between different parts of a computer program or from one program to another. In some embodiments, marshaling comprises collecting, chunking, and sequencing application state information. In some embodiments, the marshaling is coordinated by a warm-start agent. In some embodiments, the warm-start agent corresponds to warm-start agent 206a of FIG. 2. In some embodiments, the marshalling is driven by a warm-start manifest. In some embodiments, the warm-start manifest corresponds to warm-start manifest 208a. In some embodiments, the marshalling comprises the warm-start agent 206a reading the warm-start manifest 208a to obtain a list of application state elements. In some embodiments, marshaling further comprises identifying the applications associated with those application state elements. In some embodiments, the application state data is stored in the cache as records. In some embodiments, the warm-start agent sends the application state data to a warm-start service. In some embodiments, the warm-start service corresponds to warm-start service 142 of FIG. 1 and FIG. 2.

In some embodiments, the warm-start service 142 forwards the application state data elements to a second warm-start agent executing in a second virtualization environment. In some embodiments, the second virtualization environment corresponds to virtualization environment 202b of FIG. 2. In some embodiments, the second warm-start agent corresponds to warm-start agent 206b of FIG. 2. In some embodiments, the warm-start service 142 forwards a warm-start manifest 208b to the second warm-start agent. In some embodiments, the second warm-start agent 206b requests the warm-start manifest from the warm-start service 142.

At block 430, the processing logic causes the warm-start agent to send the obtained application state information to the warm-start service to be delivered to a second virtualization environment. In some embodiments the warm-start service forwards the application state data to a second warm-start agent in a second virtualization environment. In some embodiments the second warm-start agent corresponds to warm-start agent 206b in FIG. 2. In some embodiments, the second virtualization environment corresponds to virtualization environment 202b in FIG. 2. Upon receipt of the application state data, the warm-start agent may populate a cache with the application state data. This can support a scenario in which the target containers and their respective applications are not yet active. In some embodiments, the cache may correspond to cache 210b of FIG. 2. As the cache is populated, the warm-start agent may cause the virtualization environment to launch one or more applications. As the virtualization environment launches applications, the warm-start agent may begin to provide application state data from the cache to the applications. In some embodiments, in which the applications in the second virtualization environment are already instantiated, the warm-start agent can directly provide application state data to those applications, obviating the use of a cache. In some embodiments, the application state data is provided in chunks, the order of transmission of the chunks (the priority of the chunks) determined by the individual applications. In some embodiments, the chunks are prioritized by the applications in a manner that optimizes the performance of the target system in the event that all of the application's state data cannot be copied from the source system to the target system before eviction. In some embodiments, an application may first transfer application state information designated as primary. In some embodiments, after transferring primary application state data, an application may then transfer secondary application state data. In between the transfer of primary application state data and secondary application state data, the warm-start agent may, using the contents of a manifest, cause primary application state data of other applications to be transferred before allowing secondary application state information to transfer. In some embodiments, network bandwidth notwithstanding, the warm-start agent can support application state data of multiple applications to be transferred simultaneously. In some embodiments, the warm-start agent may obtain a list of applications, a list of application state data, instructions, and an order of operation from a warm-start manifest. In some embodiments, the warm-start agent may obtain the warm-start manifest from the warm-start service 142. In some embodiments, the warm-start manifest may correspond to warm-start manifest 208b. In some embodiments, application state information can be transferred in self-contained chunks. In some embodiments, the chunks are prioritized. In some embodiments, this prioritization allows more important chunks to be moved first, to anticipate a scenario in which eviction of the source system completes before all the chunks of application state information are successfully moved to the target system. In some embodiments, prioritization can be static, e.g., by application according to a manifest, or dynamic, e.g., across all application with input from the application which specifies which state information is more valuable.

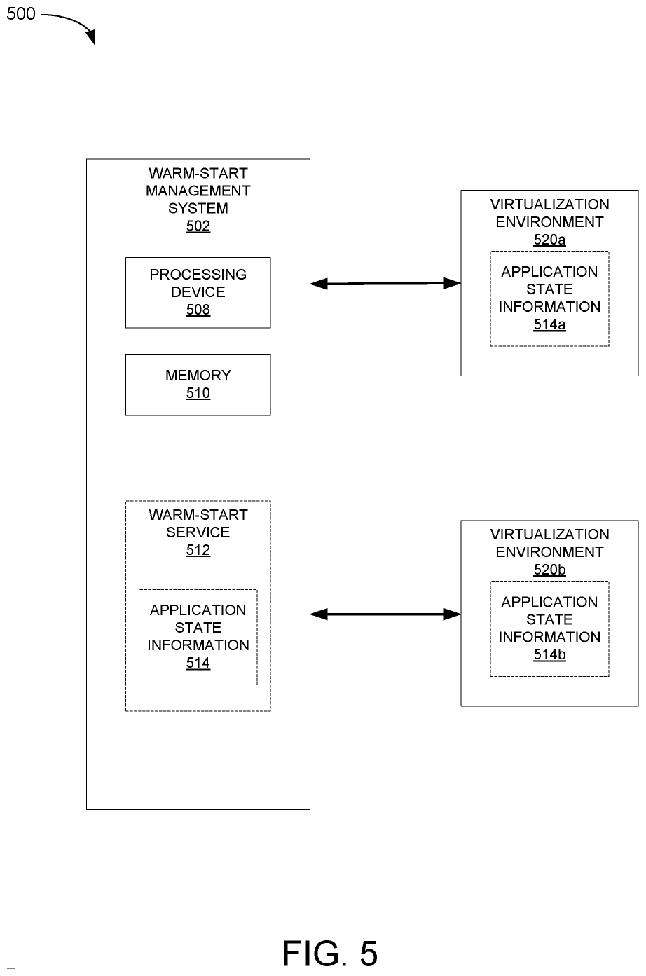

FIG. 5 is a component diagram depicting an example warm-start management architecture 500, in accordance with embodiments of the disclosure. The warm-start management architecture 500 includes warm-start management system 502, processing device 508, memory 510, warm-start service 512, application state information 514, first virtualization environment 520a, and second virtualization environment 520b. Warm-start management system 502 may correspond to host system 110a of FIG. 1. Warm-start management system 502 may include an execution environment that may correspond to execution environment 130 of FIG. 1. An execution environment included in warm-start management system 502 may include VMs, containers, or one or more containers within a VM. Such a collection of VMs, containers, or one or more containers within a VM, may comprise a virtualization environment. A virtualization environment may include any combination of VMs and containers. Warm-start management system 502 may include any number of execution environments. Warm-start management system 502 may correspond to warm-start management system 140 of FIG. 1. Warm-start service 512 may correspond to warm-start service 142 of FIG. 1. In some embodiments, processing device 508 may correspond to processing device 160a of FIG. 1. In some embodiments, memory 510 may include volatile memory devices, e.g., random access memory (RAM), non-volatile memory devices, e.g., flash memory, and/or other types of memory devices.

Warm-start management system 502 may receive notification of an eviction on virtualization environment 520a, causing processing device 508 and memory 510 to submit instructions to virtualization environment 520a to obtain application state information 514a, and send it to warm-start service 512. In some embodiments, warm-start service 512 sends application state information 514 to virtualization environment 520b. At the beginning of the process, in some embodiments, application state information 514b is empty. In some embodiments, the total application state information that is desired to be transferred comprises application state information 514a, as included in virtualization environment 520a. Some or all of application state information 514a may be transferred to warm-start management system 502 as application state information 514. In some embodiments, the portion of application state information 514a that is successfully transferred to warm-start management system 502 is subsequently transferred to virtualization environment 520b as application state information 514b. In some embodiments, application state 514a is moved directly from virtualization environment 520a to application state 514b in virtualization environment 520b. At the completion of the process, in some embodiments, application state information 514b may be empty, may be equivalent to application state information 514a, or may contain some portion of application state information 514a. In some embodiments, virtualization environment 520a corresponds to virtualization environment 202a of FIG. 2. In some embodiments, virtualization environment 520b corresponds to virtualization environment 202b of FIG. 2. It should be noted that warm-start service 512, application state information 514, 514a, 514b, first virtualization environment 520a, and second virtualization environment 520b are shown for illustrative purposes only and are not physical components of warm-start management system 502.

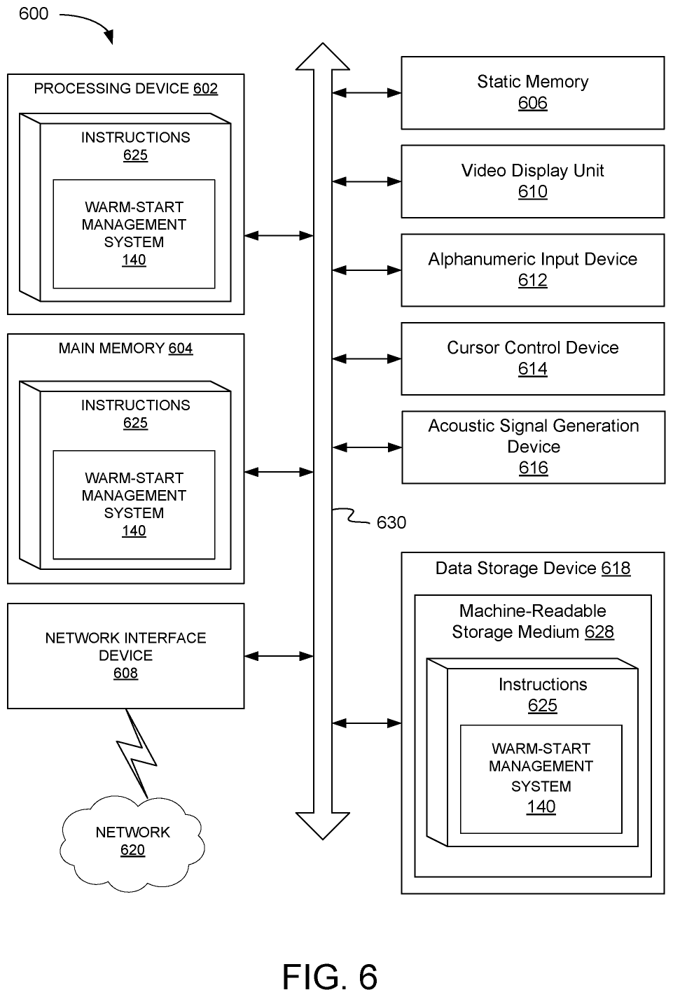

FIG. 6 is a block diagram of an example computing device 600 that may perform one or more of the operations described herein, in accordance with some embodiments. Computing device 600 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, a switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 600 may include a processing device 602, e.g., a general-purpose processor or a programmable logic device (PLD), a main memory 604, e.g., a synchronous dynamic random-access memory (DRAM) or a read-only memory (ROM), a static memory 606, e.g., flash memory, and a data storage device 618, which may communicate with each other via a bus 630.

Processing device 602 may be provided by one or more general-purpose processing devices such as a microprocessor, central processing unit, or the like. In an illustrative example, processing device 602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may also include one or more special-purpose processing devices such as an application specific integrated circuit (ASIC), a field programmable gate array (FPGA), a digital signal processor (DSP), a network processor, or the like. The processing device 602 may be configured to execute the operations described herein, in accordance with one or more aspects of the present disclosure, for performing the operations and steps discussed herein.

Computing device 600 may further include a network interface device 608 which may communicate with a network 620. The computing device 600 also may include a video display unit 610, e.g., a liquid crystal display (LCD) or a cathode ray tube (CRT), an alphanumeric input device 612, e.g., a keyboard, a cursor control device 614, e.g., a mouse, and an acoustic signal generation device 616, e.g., a speaker. In one embodiment, video display unit 610, alphanumeric input device 612, and cursor control device 614 may be combined into a single component or device, e.g., an LCD touch screen.

Data storage device 618 may include a computer-readable storage medium 628 on which may be stored one or more sets of instructions 625 that may include instructions for an warm-start management system 140, further including an warm-start management service (not shown) for carrying out the operations described herein, in accordance with one or more aspects of the present disclosure. Instructions 625 may also reside, completely or at least partially, within main memory 604 and/or within processing device 602 during execution thereof by computing device 600, main memory 604 and processing device 602 also constituting computer-readable media. The instructions 625 may further be transmitted or received over a network 620 via network interface device 608.

While computer-readable storage medium 628 is shown in an illustrative example to be a single medium, the term “computer-readable storage medium” should be taken to include a single medium or multiple media, e.g., a centralized or distributed database and/or associated caches and servers, which stores the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “receiving,” “obtaining,” “sending,” “storing,” or the like, refer to actions and processes performed or implemented by computing devices that manipulate and transform data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times, or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” connotes structure by indicating that the units/circuits/components include structure, e.g., circuitry, which performs the task or tasks during operation. As such, the unit/circuit/component can be said to be configured to perform the task, or is configurable to perform the task, even when the specified unit/circuit/component is not currently operational, e.g., is not on. The units/circuits/components used with the “configured to” or “configurable to” language include hardware, e.g., circuits and memory storing program instructions executable to implement the operation. Reciting that a unit/circuit/component is “configured to” perform one or more tasks, or is “configurable to” perform one or more tasks, is expressly intended to not invoke 35 U.S.C. § 112(f) for that unit/circuit/component. Additionally, “configured to” or “configurable to” can include generic structure, e.g., generic circuitry, which is manipulated by software and/or firmware, e.g., an FPGA or a general-purpose processor executing software, to operate in manner that is capable of performing the task(s) at issue. “Configured to” may also include adapting a manufacturing process, e.g., a semiconductor fabrication facility, to fabricate devices, e.g., integrated circuits, which are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
receiving a shutdown notification for a first virtualization environment;
obtaining, by a processing device, application state information associated with an application executing on the first virtualization environment, the application state information divided into chunks; and
sending the obtained application state information to a warm-start service to be delivered to a second virtualization environment.

2. The method of claim 1, wherein the application state information is divided into chunks by the application.

3. The method of claim 1, wherein dividing the application state information into chunks is based at least in part on read prediction probability.

4. The method of claim 1, wherein the application state information is sent to the warm-start service in a priority order determined by the application.

5. The method of claim 1, wherein the application state information is sent to the warm-start service according to criteria stored in a warm-start manifest.

6. The method of claim 1, wherein sending the application state information to the warm-start service is performed in accordance with a policy.

7. The method of claim 1, wherein the priority is based on querying, via an API, the application as it terminates.

8. A system comprising:
a memory; and
a processing device, operatively coupled to the memory, to:
receive a shutdown notification for a first virtualization environment;
obtain application state information associated with an application executing on the first virtualization environment, the application state information divided into chunks; and
send the obtained application state information to a warm-start service to be delivered to a second virtualization environment.

9. The system of claim 8, wherein the application state information is divided into chunks by the application.

10. The system of claim 8, wherein chunks comprising metadata are obtained before chunks comprising data.

11. The system of claim 8, wherein to divide the application state information into chunks is based at least in part on read prediction probability.

12. The system of claim 8, wherein to obtain the application state information, the processing device is further to: send the application state information to the warm-start service in a priority order determined by the application.

13. The system of claim 8, wherein to obtain the application state information, the processing device is further to: send the application state information to the warm-start service according to criteria stored in a warm-start manifest.

14. The system of claim 8, wherein the priority is based on querying, via an API, the application as it terminates.

15. A non-transitory computer-readable storage medium including instructions that, when executed by a processing device, cause the processing device to:
receive a shutdown notification for a first virtualization environment;
obtain, by the processing device, application state information associated with an application executing on the first virtualization environment, the application state information divided into chunks; and
send the obtained application state information to a warm-start service for delivery to a second virtualization environment.

16. The non-transitory computer-readable storage medium of claim 15, wherein the application state information is divided into chunks by the application.

17. The non-transitory computer-readable storage medium of claim 15, wherein the instructions further cause the processing device to obtain chunks comprising metadata before chunks comprising data.

18. The non-transitory computer-readable storage medium of claim 15, wherein the instructions further cause the processing device to send the application state information to the warm-start service in a priority order determined by the application.

19. The non-transitory computer-readable storage medium of claim 15, wherein the instructions further cause the processing device to send the application state information to the warm-start service according to criteria stored in a warm-start manifest.

20. The non-transitory computer-readable storage medium of claim 15, wherein the priority is based on querying, via an API, a terminating application.
